(19) United States
(12) Patent Application Publication
(10) Pub. No.: US 2008/0286403 A1
(43) Pub. Date: Nov. 20, 2008

(54) Air Ring for a Stripper Assembly

(75) Inventors: Ralf Walter FISCH, Saarburg (DE); Sven KMOCH, Platten (DE)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd., Bolton (CA)

(21) Appl. No.: 11/749,186

(22) Filed: May 16, 2007

(51) Int. Cl. B29C 35/16

(52) U.S. Cl. 425/549

(57) ABSTRACT

An air ring is provided for a stripper plate assembly. The air ring is removably situated within bores defined in the stripper plate. An air manifold is also defined within the stripper plate, which is connected to a pressurized air source for communication of a pressurized air flow to each of the bores air ducts within each air ring direct the pressurized air flow from the air manifold towards a preferred location on the molded article that passed through the air ring.

### FIELD OF THE INVENTION

The present invention generally relates to molding assemblies. More specifically, the present invention relates to the removal of molded articles from a molding assembly.

### BACKGROUND OF THE INVENTION

Injection molding is a commonly employed manufacturing technique for forming articles. Various molded articles can be formed by using the molding process. One example of a molded article that can be formed, for example, from polyethylene terephalate (PET) material is a preform that is capable of being subsequently blown into a beverage container, such as, a bottle and the like.

As an illustration, injection molding of PET material involves heating the PET material (ex. PET pellets, PEN powder, PLA, etc.) to a homogeneous molten state and injecting it, under pressure into a molding cavity defined, at least in part, by a female cavity piece and a complementary male core piece mounted respectively on a cavity plate and a core plate of the mold. The cavity plate and the core plate are urged together and are held together by clamp force, the clamp force being sufficient enough to keep the cavity and the core pieces together against the pressure of the injected PET material. The molding cavity has a shape that substantially corresponds to a final cold-state shape of the molded article to be molded. The molded article is then cooled to a temperature sufficient to enable ejection from the mold.

When cooled, the molded article shrinks inside of the molding cavity and, as such, when the cavity and core plates are urged apart, the molded article tends to remain associated with the core piece, necessitating the use of one or more ejection mechanisms. Examples of the ejection mechanism include stripper plates, ejector pins, robots, etc. Pressurized air flow directed at the molded articles can also be used to assist in the removal of the molded article from the mold core.

U.S. Pat. No. 4,438,065 to Paul Brown (issued Mar. 20, 1984) teaches an injection molding apparatus for a container, where the apparatus includes a core defining the interior of the container and first means within the core for initiating ejection of a molded container from the core. The improvement consists of second means adjacent the rim of the molded container for blowing a gaseous material toward the container rim, thereby completing ejection by urging the container away from the core.

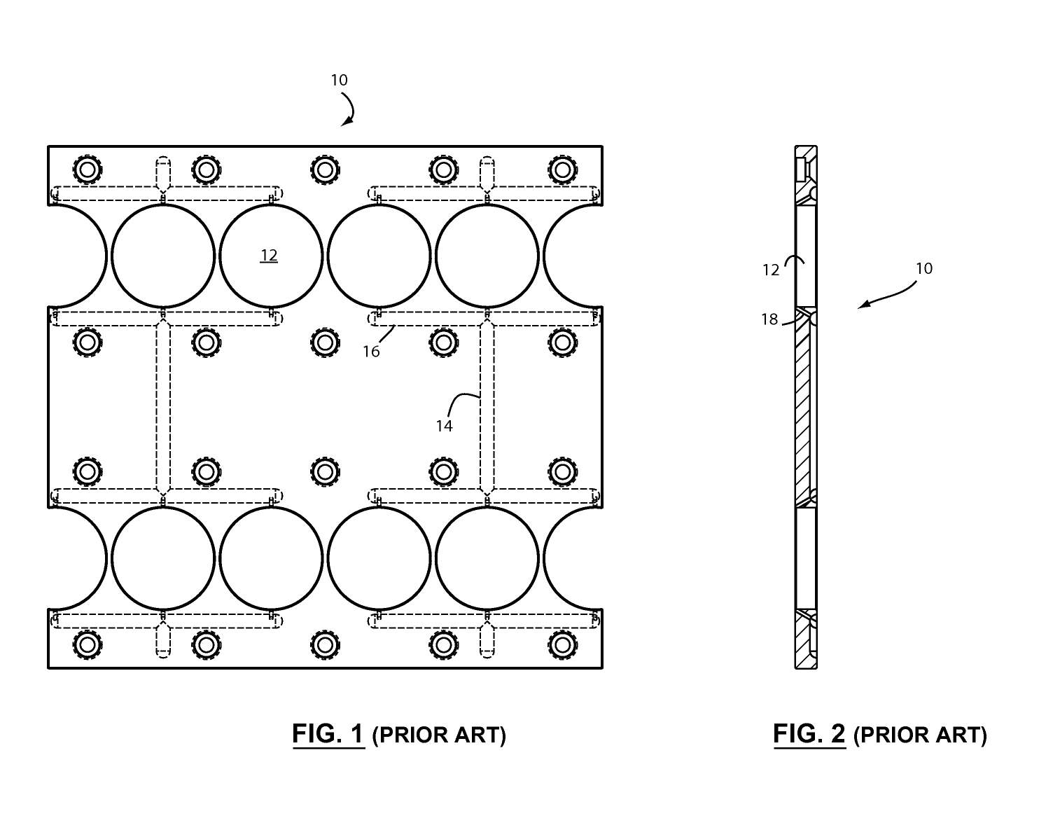

FIGS. 1 and 2 show an example of a stripper plate manufactured by the assignee of this invention. A stripper plate 10, which is situated between two mold portions (not shown), includes a plurality of bores 12 for pass through of a mold core (also not shown). Pressurized air is routed through an air manifold 14. Air manifold 14 directs the pressurized air through a number of channels 16. The air exits the channels 16 through air ducts 18, which are adjacent the bores 12. Air ducts 18 direct the pressurized air towards the molded articles (not shown) to dismount them from their respective mold cores.

Due to various business considerations, an entity operating the molding system may choose to re-configure the molding system, for example, to change the shape of the preform to be produced. For example, the entity operating the molding system may choose to change the molding cavities (by exchanging mold cavities inserts, etc.) to produce preforms having a larger height, width and/or weight. Should this occur, the entity operating the molding system will need to adjust the ejection mechanism for the new preform.

### SUMMARY OF THE INVENTION

According to a first broad aspect of the invention, there is provided a stripper plate assembly. The stripper plate defines at least one bore, each of the at least one bore for passthrough of a mold core. An air manifold is defined within the stripper plate, operable to be connected to a pressurized air source for communication of a pressurized air flow to each of the at least one bore. An air ring is removably situated within each of the at least one bore, defining at least one air duct operable to direct the pressurized air flow from the air manifold towards a preferred location on a molded article that is attached to the mold core.

According to a second broad aspect of the invention, there is provided an air ring for an injection molding system, comprising a generally cylindrical body that is removably situated within a bore on a plate in the injection molding system. The air ring defines at least one air duct operable to direct a pressurized air flow received at a first end of the at least one air duct out through a second end of the at least one air duct.

According to a third broad aspect of the invention, there is provided an injection molding system having a first mold portion and a second mold portion. A mold cavity is defined on one of the first mold portion and the second mold portion. A mold core is defined on the other of the first mold portion and the second mold portion. An injection assembly is operable to convey a molding material to the first mold portion. A stripper plate is located between the first mold portion and the second mold portion, and defines at least one bore, each of the at least one bore for passthrough of a molded article located on the mold core. An air manifold is defined within the stripper plate, operable to be connected to a pressurized air source for communication of a pressurized air flow to each of the at least one bore. An air ring is removably situated within each of the at least one bore, defining at least one air duct operable to direct the pressurized air flow from the air manifold towards a preferred location on a molded article attached to the mold core.

### DETAILED DESCRIPTION OF DRAWINGS

Objects and advantages of the present invention will become apparent to those skilled in the art upon reading the following detailed description of non-limiting embodiments of the present invention, in conjunction with the accompanying drawings, wherein like reference numerals have been used to designate like elements, and wherein:

FIG. 1 provides a top plan view of a stripper plate, according to a prior art design;

FIG. 2 provides a cross-sectional view of the prior art stripper plate shown in FIG. 1;

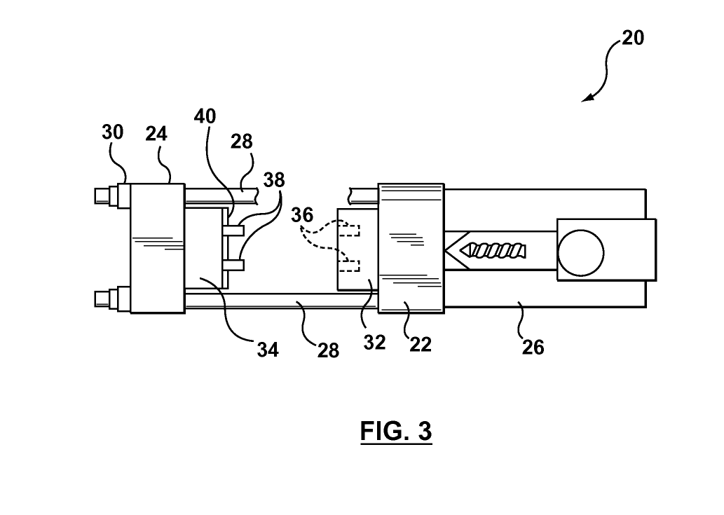

FIG. 3 provides a schematic view of an injection molding system, according to a non-limiting embodiment of the present invention;

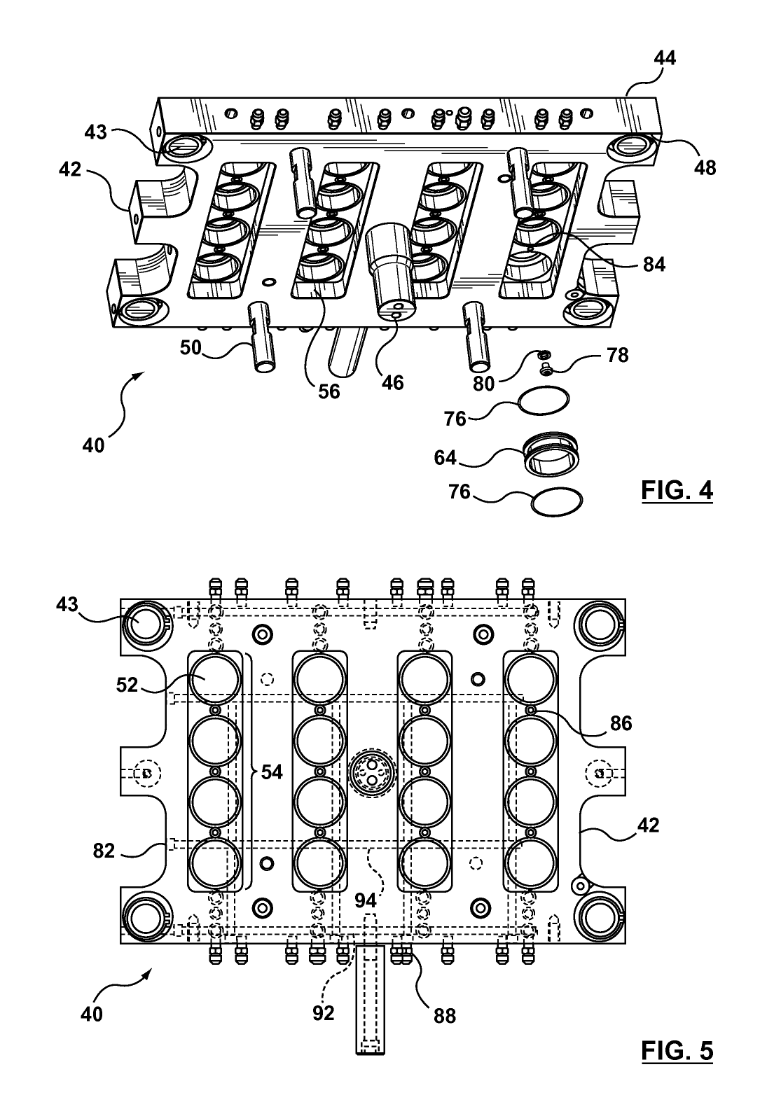

FIG. 4 provides a perspective view of a stripper plate assembly for the injection molding system shown in FIG. 3;

FIG. 5 provides a bottom plan view of the stripper plate assembly shown in FIG. 4;

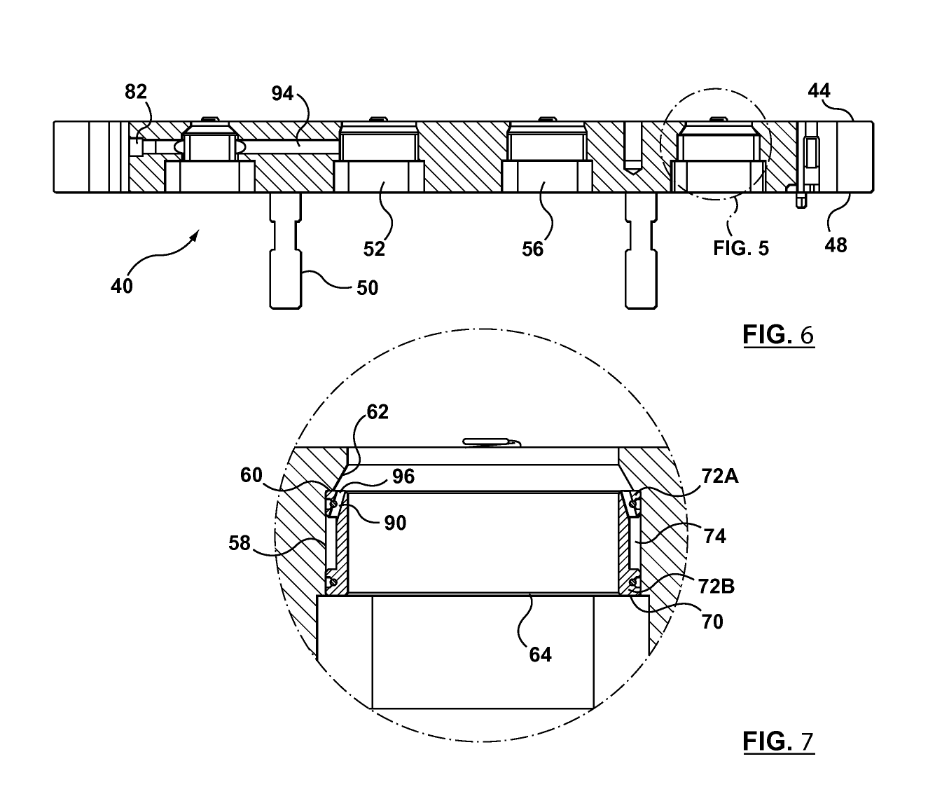

FIG. 6 provides a cross-sectional view of the stripper plate assembly shown in FIG. 4;

FIG. 7 provides a cross-sectional view of a portion of the stripper plate assembly shown in FIG. 4;

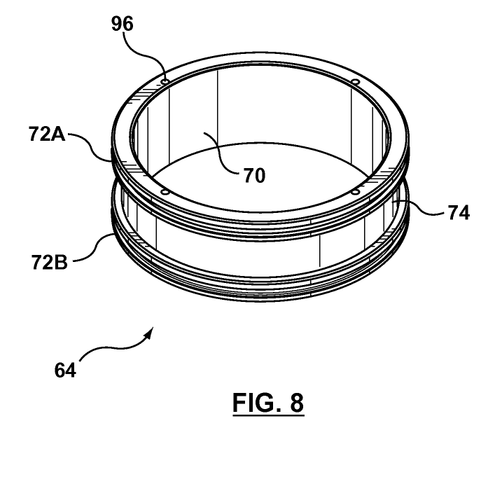

FIG. 8 shows a perspective view of an air ring for the stripper plate assembly shown in FIG. 4; and

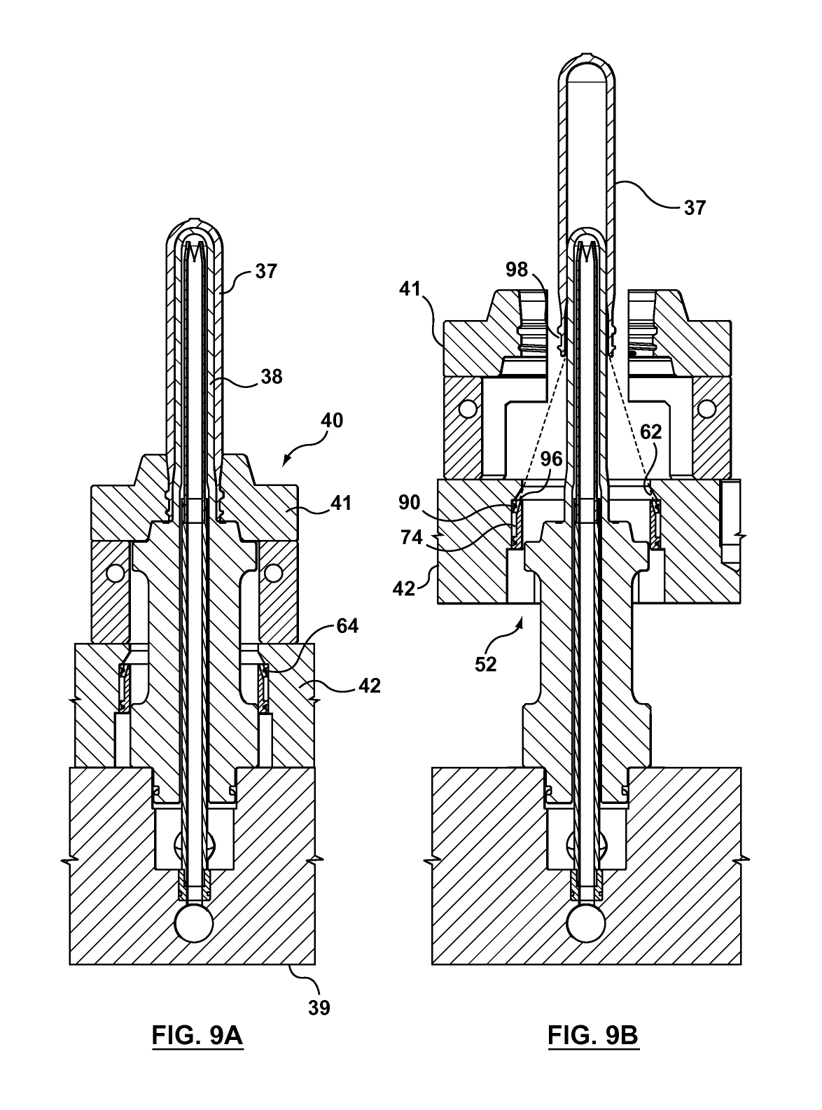

FIGS. 9A and 9B show a cross sectional view of a portion of the injection molding machine shown in FIG. 3, showing the release of a molded article.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF THE EMBODIMENTS

With reference to FIG. 3, there is depicted a non-limiting embodiment of an injection molding system 20 which can be adapted to implement embodiments of the present invention. For illustration purposes only, it shall be assumed that the injection molding system 20 is adapted for processing a thermoplastic molding material, such as, PET for example. However, it should be understood that in alternative non-limiting embodiments, the molding system 20 may comprise other types of molding systems, such as, but not limited to, injection molding system, compression molding systems, metal molding systems and the like. It should be further understood that embodiments of the present invention are applicable to the molding system 20 incorporating any multicavitation mold, including PET molds, thinwall articles molds, closures molds and the like.

Within the non-limiting embodiment of FIG. 3, the molding system 20 comprises a fixed platen 22 and a movable platen 24. The molding system 20 further comprises an injection assembly 26 for plasticizing and injection of the molding material. In operation, the movable platen 24 is moved towards and away from the fixed platen 22 by means of stroke cylinders (not shown) or any other suitable means. Clamp force (also referred to as closure or mold closure tonnage) can be developed within the molding system 20, for example, by using tie bars 28 and a tie-bar clamping mechanism 30, as well as an associated hydraulic system (not depicted) associated with the tie-bar clamping mechanism 30. It will be appreciated that clamp tonnage can be generated using alternative means, such as, for example, using a toggle-clamp arrangement (not depicted) or the like.

A first mold portion 32, commonly referred to as the “hot half”, can be associated with the fixed platen 22 and a second mold portion 34, commonly referred to as the “cold half” can be associated with the movable platen 24. Each of the first mold portion 32 and second mold portion 34 can be coupled to their respective platen by any suitable means, such as fasteners (not depicted) or the like. It should be understood that in an alternative non-limiting embodiment of the present invention, the position of the first mold portion 32 and the second mold portion 34 can be reversed and, as such, the first mold portion 32 can be associated with the movable platen 24 and the second mold portion 34 can be associated with the fixed platen 22. In an alternative non-limiting embodiments of the present invention, the fixed platen 22 need not be stationary and may as well be moved in relation to other components of the molding system 20.

In the specific non-limiting embodiment of FIG. 3, the first mold portion 32 defines one or more mold cavities 36. As will be appreciated by those of skill in the art, the one or more mold cavities 36 may be formed directly within the a plate, or preferably by using suitable mold inserts located within bores in a cavity plate, or any other suitable means. The second mold portion 34 includes one or more mold cores 38, each mold core 38 being associated with, and complementary to, one of the mold cavities 36. As will be appreciated by those of skill in the art, the mold cores 38 may be attached directly to a mold core plate 39 (FIGS. 9A and 9B), or formed using mold inserts or any other suitable means. Second mold portion 34 further includes a stripper plate assembly 40 that is located between first mold portion 32 and second mold portion 34. Stripper plate assembly 40 will be described in greater detail below.

When injection molding system 20 is in a “mold closed position” (not depicted), the first mold portion 32 and the second mold portion 34 are urged together (by means of movement of the movable platen 24 towards the fixed platen 22) so that each mold core 38 enters its associated mold cavity 36. Each paired mold core 38 and mold cavity 36 cooperate to define, at least in part, a mold (not depicted) into which the molten plastic (or other suitable molding material) can be injected, as is known to those of skill in the art.

FIG. 3 depicts the injection molding system 20 in a “mold open position” where the movable platen 24 is positioned generally away from the fixed platen 22 and, accordingly, the mold core 38 is positioned generally away from the mold cavity 36. In the mold open position, a molded article 37 (FIG. 9A and 9B) can be removed from the first mold portion 32 and/or the second mold portion 34.

Naturally, the molding system 20 may comprise a number of additional components, such as a hot runner for transmission of the molding material into the mold cavities (not depicted). Furthermore, the molding system 20 may optionally or additionally comprise auxiliary equipment (not depicted), such as humidifiers, heaters and the like. All this equipment is known to those of skill in the art and, as such, will not be discussed at any length here.

Referring additionally to FIGS. 4-7 a stripper plate assembly is shown generally at 40. Stripper plate assembly is adapted to slidably mount split mold inserts 41, aka “neck rings” (FIGS. 9A and 9B). Stripper plate assembly 40 includes a stripper plate 42, which is situated between the first mold portion 32 and second mold portion 34, and as such, includes a first mold portion-facing side 44 and a second mold portion-facing side 48. In the presently-illustrated embodiment, stripper plate 42 is movably mounted to the second mold portion 34. Pass-through apertures 43 are provided for each tie bar 28. A central shaft 46 is affixed to stripper plate 42 and is operable to translate the position of stripper plate 42 relative to the remainder of second mold portion 34 when injection molding system 20 is in the open position. Central shaft 46 pushes stripper plate 42 away from the rest of second mold portion 34 while commencing the ejection of the molded component, and pulls stripper plate 42 back towards the mold core plate after the ejection of the molded component. In the presently-illustrated embodiment, central shaft 46 is motivated by an ejector cylinder (not shown), but other methods of translating central shaft 46 are within the scope of the invention. Four ejector pins 50 are provide distributed around the core-facing surface to assist in pushing the stripper plate 42 away from the rest of second mold portion 34 during the ejection step.

At least one bore 52 is defined in stripper plate 42, preferably one bore 52 for and coaxially aligned with each mold cavity 36 in the first mold portion 32. (A stripper plate 42 could have a greater number of bores 52 than the number of mold cavities 36). The bores 52 are arranged in banks 54. Each bore 52 in a bank 54 can be accessed by a common trough 56 on the second mold portion-facing side 48. Preferably, each bore 52 is defined by a cylindrical portion 58, a narrowing land portion 60, and a taper portion 62.

Each bore 52 is adapted to receive a replaceable air ring 64. Referring additionally to FIG. 8, each air ring 64 has a generally cylindrical body 70 that is open at both ends to permit passage therethrough of the mold core 38 (FIG. 9A). The diameter of cylindrical body 70 is sized slightly smaller than that of cylindrical portion 58. An annular flange 72 is provided along each end of cylindrical body 70 along its exterior surface, defining a circumferential groove 74 therebetween. A first flange, namely annular flange 72A faces the first mold portion 32 and a second flange, namely annular flange 72B faces the second mold portion 34. Each annular flange is grooved to retain an O-ring 76 (FIG. 4) so that when the air ring 64 is inserted into cylindrical portion 58, an air-tight fit is formed around each circumferential groove 74. Annular flange 72A is seated against land portion 60 to prevent the air ring 64 from exiting out of bore 52 towards the first-portion facing side. A series of fasteners 78 and washers 80 are used to secure the air rings 64 on the second-portion facing side. Each fastener 78 and washer 80 is located in a threaded aperture 84 (FIG. 4) that is located between a pair of bores 52, and includes a broad head 86 (FIG. 5) that extends over the two bores. When an air ring 64 is located within each of these two bores 52, and the fasteners 78 are tightened the broad head 86 abuts against the annular flange 72B on each of the two adjacent bores 52. Air rings 64 located along the ends of each bank 54 are retained by a single fastener 78 and washer 80, while those in-between are retained by a pair of fasteners 78 and washers 80 on diametrically opposed sides of each air ring 64 (FIG. 7).

An air intake 88 is provided along an edge of stripper plate 42, which can be operably connected to a pressure hose (not shown) for the communication of a pressurized air source. The air flow is distributed throughout the stripper plate assembly 40 via an air manifold 92. Air manifold 92 includes a series interconnecting channels 94 that are arranged in a grid-like pattern so that each bank 54 is supplied from multiple sources. The channels intersect and communicate with each of the bores 52 so that when the air rings 64 are inserted, the circumferential grooves 74 become part of air manifold 92 distributing the air flow. Plugs 82 are used to close off drilling holes in the stripper plate so that the pressurized air can only escape the air manifold 92 through the air rings 64, which is described in greater detail below.

Within each air ring 64, at least one air duct 90 is defined in each annular flange 72A. Each air duct 90 extends from circumferential groove 74 to at least one aperture 96 on the first-portion facing side of stripper plate 42.Thus, the pressurized air exits manifold 92 through the apertures 96 at an angle towards the molded article 37 (indicated by the dashed lines in FIG. 9B). The adjacent tapered portion 62 of each bore 52 helps direct the pressurized air towards the molded article 37. For a conventional molded article, such as a preform, the pressurized air is directed against the neck flanges 98 on the premolded article 37 (FIG. 9B), which thusly releases the molded article from the mold core 38.

Since the air rings are easily exchanged, specific air rings 64 can be provided for each particular molded object design. The angle of air ducts 90 can be specifically adapted for each molded object so that the pressurized air is directed towards a preferred location which provides the optimal position for part removal. In addition, the size of air ducts 90 can be adjusted to provide differing pressures that are best suited for each molded object. Furthermore, the shape of the opening for the air ducts 90 can be adjusted as is best suited for each molded object. For instance, the apertures could be simple holes, or they could be arcuate and follow the curve of the air ring 64.

An exemplarized description of the molding cycle for injection molding system 20 is now provided for illustrative purposes only. It will be appreciated that the actual operation of injection molding system 20 can vary, and include additional components and steps not depicted here. It will also be appreciated that the sequence of some steps may vary, with some steps occurring concurrently, or in differing order.

The injection molding system 20 is moved from the open position to the closed position, i.e., the first mold portion 32 and the second mold portion 34 are brought together to form the mold. Tie-bar clamping mechanism 30 clamps the first and second mold portions 32 and 34 together.

Next, the injection assembly 26 injects the molding material into the runner system (not depicted) of the first mold portion 32, where it is routed to the molds formed between mold cavities 36 and mold cores 38. Once sufficient molding material has entered the molds, the flow of molding material is stopped.

Next, cooling systems in the first and second mold portions 32, 34 cool the molded article 37 sufficiently for it to begin to solidify. Tie bar clamping mechanism 30 releases the clamping force and the injection molding system begins to move to its open position as first and second mold portions 32, 34 are separated. As it cools, the molded article 37 shrinks inside of the mold so that it typically remains attached to mold core 38 (FIG. 9A).

Concurrent with or subsequent to the separation of first and second mold portions 32, 34, the stripper plate assembly 40 is spaced apart from the remainder for second mold portion 34 by central shaft 46 and ejector pins 50.

Next, pressurized air is communicated to air manifold 92 in stripper plate 42, and is distributed through interconnecting channels 94. The air moves into the air ducts 90, where it is directed out through apertures 96 towards a preferred location on the molded articles 37 (in this embodiment, the neck flanges) attached to the mold cores 38 to demount the molded articles 37 (FIG. 9B).

Lastly, the stripper plate 42 is returned to its position adjacent the second mold portion 34, and the pressurized air flow is stopped. The injection molding system 20 is ready to commence another cycle.

A technical effect, amongst others, of the aspects of the present invention may include the ability to inexpensively and quickly produce specific air rings 64 for each particular molded object design. The angle of air ducts 90 can be specifically adapted for each molded object so that the pressurized air is directed towards a preferred location which provides the optimal position for part removal. In addition, the size of air ducts 90 can be adjusted to provide differing pressures that are best suited for each molded object. Furthermore, the shape of the opening for the air ducts 90 can be adjusted as is best suited for each molded object. It should be expressly understood that not all of the technical effects, in their entirety, need be realized in each and every embodiments of the present invention.

The description of the embodiments of the present inventions provides examples of the present invention, and these examples do not limit the scope of the present invention. It is to be expressly understood that the scope of the present invention is limited by the claims only. The concepts described above may be adapted for specific conditions and/or functions, and may be further extended to a variety of other applications that are within the scope of the present invention. Having thus described the embodiments of the present invention, it will be apparent that modifications and enhancements are possible without departing from the concepts as described. Therefore, what is to be protected by way of letters patent are limited only by the scope of the following claims:

What is claimed is:

1. A stripper plate assembly comprising:
a stripper plate defining at least one bore, each of the at least one bore for passthrough of a mold core;
an air manifold defined within the stripper plate, operable to be connected to a pressurized air source for communication of a pressurized air flow to each of the at least one bore;
an air ring, removably situated within each of the at least one bore, defining at least one air duct operable to direct the pressurized air flow from the air manifold towards a preferred location on a molded article attached to the mold core.

2. The stripper plate assembly of claim 1, wherein the pressurized air flow urges the molded article to detach from its respective mold core.

3. The stripper plate assembly of claim 1, wherein the pressurized air flow cools the molded article.

4. The stripper plate assembly of claim 1, wherein the air manifold includes plurality of channels, and at least some of the plurality of channels are in communication with more than one of the at least one bore.

5. The stripper plate assembly of claim 1, wherein the air ring includes an circumferential groove on an exterior surface of the air ring, the circumferential groove being in communication with the at least one air duct.

6. The stripper plate assembly of claim 5, wherein the circumferential groove is defined between a pair of opposing flanges on the exterior surface of the air ring.

7. The stripper plate assembly of claim 5, wherein the at least one air duct is located in a first flange, the first flange being located on a stationary-portion facing side of the stripper plate assembly.

8. The stripper plate assembly of claim 5, wherein an angle of the at least one air duct in the air ring is specifically adapted for the molded article.

9. The stripper plate assembly of claim 5, wherein in the size of an aperture exiting the at least one air duct is specifically adapted for the molded article.

10. The stripper plate assembly of claim 5, wherein in the shape of an aperture of the at least one air duct is specifically adapted for the molded article.

11. The stripper plate assembly of claim 1, wherein the at least one bore comprises a plurality of bores, and the plurality of bores are organized into banks joined by a common trough.

12. The stripper plate assembly of claim 1, wherein each bore includes a land portion for supporting the air ring on a first side.

13. The stripper plate assembly of claim 1, wherein fasteners having flanges are used to retain the air ring on a second side.

14. The stripper plate assembly of claim 1, wherein each bore includes a tapered portion for direction of the pressurized air flow towards the molded article.

15. A molded object manufactured using an injection molding system having a stripper plate assembly in accordance with stripper plate assembly of claims 1-14.

16. An air ring for an injection molding system, comprising a generally cylindrical body that is removably situated within a bore on a plate in the injection molding system, the air ring defining at least one air duct operable to direct a pressurized air flow received at a first end of the at least one air duct out through a second end of the at least one air duct.

17. The air ring of claim 16, wherein the first end of the at least one air duct is in communication with an air manifold in the plate, and the second end directs the pressurized air towards a preferred location on a molded article that extends through the cylindrical body.

18. The air ring of claim 17, wherein the pressurized air flow urges the molded article to detach from an associated mold core.

19. The air ring of claim 17, wherein the pressurized air flow cools the molded article.

20. The air ring of claim 17, wherein the air ring includes an circumferential groove on an exterior surface of the air ring, the circumferential groove being in communication with the at least one air duct.

21. The air ring of claim 20, wherein the circumferential groove is defined between a pair of opposing flanges on the exterior surface of the air ring.

22. The air ring of claim 20, wherein the at least one air duct is located in a first flange, the first flange being located on a stationary-portion facing side of the plate.

23. The air ring of claim 20, wherein an angle of the at least one air duct in the air ring is specifically adapted for the molded article.

24. The air ring of claim 20, wherein in the size of an aperture exiting the at least one air duct is specifically adapted for the molded article.

25. The air ring of claim 20, wherein in the shape of an aperture of the at least one air duct is specifically adapted for the molded article that extends through the air ring.

26. A molded object manufactured using the air ring in accordance with the air ring of claims 16-25.

27. An injection molding system having a first mold portion and a second mold portion, comprising:
a mold cavity being defined on one of the first mold portion and the second mold portion;
a mold core being defined on the other of the first mold portion and the second mold portion;
an injection assembly operable to convey a molding material to the first mold portion;
a stripper plate, located between the first mold portion and the second mold portion, and defining at least one bore, each of the at least one bore for passthrough of a molded article located on the mold core;
an air manifold defined within the stripper plate, operable to be connected to a pressurized air source for communication of a pressurized air flow to each of the at least one bore;
an air ring, removably situated within each of the at least one bore, defining at least one air duct operable to direct the pressurized air flow from the air manifold towards a preferred location on a molded article that is attached to the mold core.
